(19) United States
(12) Patent Application Publication
(10) Pub. No.: US 2015/0324211 A1
(43) Pub. Date: Nov. 12, 2015

(54) CHANGE PLANNING SYSTEM, CHANGE PLANNING METHOD, AND CHANGE PLANNING PROGRAM

(71) Applicants: NEC CORPORATION, Tokyo (JP); VANDERBILT UNIVERSITY, Nashville, TN (US)

(72) Inventors: Takayuki KURODA, Tokyo (JP); Aniruddha Suresh GOKHALE, Nashville, TN (US)

(73) Assignees: VANDERBILT UNIVERSITY, Nashville, TN (US); NEC CORPORATION, Tokyo (JP)

(21) Appl. No.: 14/471,802

(22) Filed: Aug. 28, 2014

Related U.S. Application Data
(60) Provisional application No. 61/991,075, filed on May 9, 2014.

(51) Int. Cl. G06F 9/44

(52) U.S. Cl. CPC G06F 9/4421

(57) ABSTRACT

A change planning system includes a state machine set conversion unit 11 which converts a state machine set made up of one or more state machines, into a single state machine including one or more states, wherein a state in a state machine included in the state machine set transitions to another state according to a transition condition designating a state in a state machine included in the state machine set other than the state machine, wherein a state in the single state machine corresponds to a state of all state machines in the state machine set, and wherein, while the transition condition according to which the state in the state machine makes a predetermined transition is satisfied, the state in the single state machine transitions to another state corresponding to another state of all state machines that results from the predetermined transition.

This application is based upon and claims the benefit of priority from U.S. provisional application No. 61/991,075, filed on May 9, 2014, the disclosure of which is incorporated here in its entirety by reference.

### TECHNICAL FIELD

The present invention relates to a change planning system, a change planning method, and a change planning program.

### BACKGROUND ART

Change management is intended to, upon changing a system, reduce the work of the manager and the change operator of the system to be changed and the influence on the users of the system to be changed. For example, in the case where the system to be changed is a complex system made up of a plurality of components, the change operation is complex. The complex change operation increases the work of the operator and the manager who supervises the operation by the operator. This affects the users of the system more significantly.

Particularly in the case where the components constituting the system have dependence relationships, the change operation tends to be complex because the order in which the components undergo the change operation is critical. Suppose the system includes a component A and a component B. The dependence between the components is the relationship between two elements such that, for the component A to function properly, the component B needs to function properly.

The component A depends on the component B in the above-mentioned example. Operations to construct the system including the component A and the component B need to be ordered so that the component B is constructed first and the component A is constructed next.

A change planning system is a system that automatically generates a plan of operations necessary to change the system while taking such dependence into consideration. Note that a change planning system in the present invention is a system that derives necessary operations and an appropriate operation procedure from input data that includes: the current state of each component; and the desired state of each component after the change. In the change planning system, information about the dependence between the components and information about the operations for the components are defined beforehand.

With use of the above-mentioned change planning system, the manager can efficiently generate the operation procedure effective in carrying out the complex change operation, and the operator can efficiently carry out the operation on the basis of the generated effective operation procedure. This is expected to reduce the influence on the users of the system to be changed.

A number of studies and products related to such a change planning system are already known. Examples of the related studies are the studies described in Non Patent Literatures (NPLs) 1 to 5. Examples of the related products are the products described in NPLs 6 to 9.

These related techniques are roughly classified into two types on the basis of the following viewpoint: whether or not the number of operations necessary to change one component from the current state to the desired state is assumed to be at most one.

For instance, in the case of planning operations for a system that is wholly composed of software or in the case of planning construction operations upon starting constructing a system from the very beginning, the above-mentioned assumption is often expected to be adequate. However, the above-mentioned assumption may become problematic in, for example, the following case.

Consider the case of planning operations to construct a system including middleware A, as an example. The middleware A included in the system is dependent on a temporary file B. It is desirable to remove the temporary file B after constructing the middleware A.

An operation procedure required for construction of such a system involves “1. install the temporary file B”, “2. construct the middleware A”, and “3. delete the temporary file B”. If this operation procedure is employed, two operations are necessary for the temporary file B. The employed operation procedure thus deviates from the above-mentioned assumption.

The study and product described in NPLs 3 and 6 conform to the above-mentioned assumption. Therefore, the operator cannot construct the system according to the operation procedure stated above, in the case of using any of the study and product described in NPLs 3 and 6. To construct the system according to the operation procedure, an additional program needs to be designated. In other words, a method that deviates from the original use of the study or product is needed to address the problem.

The studies described in NPLs 1, 2, 4, and 5 can generate a system change plan without the above-mentioned constraint. Hence, a system change plan in which the number of operations for one component is one can be generated without the need for a method that deviates from the original use.

The studies described in NPLs 1, 2, and 4, however, have a problem in that operations are defined in a complex way. In the studies described in NPLs 1, 2, and 4, operations are defined separately from components. The definitions of operations influence a plurality of components and the states of components.

In the product described in NPL 6, operations are defined in association with specific components. Moreover, the operations to be defined are limited to operations of changing the states of specific components. As compared with the way of defining operations in NPL 6, the ways of defining operations in NPLs 1, 2, and 4 are complex as the definition for one operation includes a lot of information.

The ways of defining operations in NPLs 1, 2, and 4 are problematic in that the method of computation when generating a change plan based on definitions tends to be complex and the reusability of the definitions is low. The reason for the low reusability of the definitions is that the definition of an operation influencing many components is used only in the case of processing such a change request that needs the influenced many components simultaneously.

NPL 5 describes a method of defining a system to be managed as multiple state machine sets. According to the method described in NPL 5, a transition condition of a transition in each state machine set is described using a state in a state machine other than the state machine including the transition.

A state machine represents a component included in the system. A state in the state machine represents a possible state of the component. A transition includes information of an operation when changing the state of the component. A transition condition represents the dependence of the operation corresponding to the information included in the transition.

A change plan based on the system definition method described above is expected to be more effective than change plans based on other methods, because a wide range of situations can be planned and definitions are reusable. The present invention is intended for a system based on this definition method. The intended system is hereafter simply referred to as “change planning system”.

The change plan for the system described as the state machine set is generated by determining, when all state machines have the current state and at least one of the state machines has the desired state, the transition order for enabling all state machines in which the desired state is designated to transition from the current state to the desired state while satisfying transition conditions. NPL 5 describes such a change plan generation method.

### CITATION LIST

### Non Patent Literature(s)

NPL 1: A. Keller, J. Hellerstein, J. Wolf, K.-L. Wu, and V. Krishnan, “The champs system: change management with planning and scheduling,” in Network Operations and Management Symposium, 2004. NOMS 2004. IEEE/IFIP, vol. 1, April 2004, pp. 395-408 Vol. 1.
NPL 2: K. El Maghraoui, A. Meghranjani, T. Eilam, M. Kalantar, and A. V. Konstantinou, “Model driven provisioning: Bridging the gap between declarative object models and procedural provisioning tools,” in Proceedings of the 7th ACM/IFIP/USENIX International Conference on Middleware, ser. Middleware '06. Berlin, Heidelberg: Springer-Verlag, 2006, pp. 404-423.
NPL 3: T. Eilam, M. Elder, A. Konstantinou, and E. Snible, “Pattern-based composite application deployment,” in Integrated Network Management (IM), 2011 IFIP/IEEE International Symposium on, 2011, pp. 217-224.
NPL 4: U. Breitenb\ddot{}ucher, T. Binz, O. Kopp, and F. Leymann, “Pattern-based Runtime Management of Composite Cloud Applications,” in Proceedings of the 3rd International Conference on Cloud Computing and Service Science, CLOSER 2013. SciTePress Digital Library, May 2013, Conference Paper.
NPL 5: S. Hagen and A. Kemper, “Model-based planning for state-related changes to infrastructure and software as a service instances in large data centers,” in Cloud Computing (CLOUD), 2010 IEEE 3rd International Conference on, July 2010, pp. 11-18.
NPL 6: puppet labs, “Learning Puppet,” 2013, pp. 1-76.
NPL 7: “An Overview of Chef”, [online], CHEF DOCUMENTS, [search on Jul. 15, 2014], docs.opscode.com/chef overview.html.
NPL 8: I. Redbooks, Virtualization With IBM Workload Deployer: Designing and Deploying Virtual Systems. Vervante, 2011.
NPL 9: T. Binz, G Breiter, F. Leyman, and T. Spatzier, “Portable cloud services using tosca,” Internet Computing, IEEE, vol. 16, no. 3, pp. 80-85, 2012.

### SUMMARY

An exemplary object of the present invention is to provide a change planning system, a change planning method, and a change planning program that can generate a change plan from a state machine set including a transition condition, using an efficient computation algorithm.

A change planning system according to the present invention includes a state machine set conversion unit which converts a state machine set made up of one or more state machines, into a single state machine including one or more states, wherein a state in a state machine included in the state machine set transitions to another state according to a transition condition designating a state in a state machine included in the state machine set other than the state machine, wherein a state in the single state machine corresponds to a state of all state machines in the state machine set, and wherein, while the transition condition according to which the state in the state machine makes a predetermined transition is satisfied, the state in the single state machine transitions to another state corresponding to another state of all state machines that results from the predetermined transition.

A change planning method according to the present invention is a change planning method executed in a change planning system for converting a state machine set made up of one or more state machines into a single state machine including one or more states, wherein a state in a state machine included in the state machine set transitions to another state according to a transition condition designating a state in a state machine included in the state machine set other than the state machine, wherein a state in the single state machine corresponds to a state of all state machines in the state machine set, and wherein, while the transition condition according to which the state in the state machine makes a predetermined transition is satisfied, the state in the single state machine transitions to another state corresponding to another state of all state machines that results from the predetermined transition.

A non-transitory computer-readable recording medium having recorded therein a change planning program according to the present invention that, when executed by a computer, converts a state machine set made up of one or more state machines, into a single state machine including one or more states, wherein a state in a state machine included in the state machine set transitions to another state according to a transition condition designating a state in a state machine included in the state machine set other than the state machine, wherein a state in the single state machine corresponds to a state of all state machines in the state machine set, and wherein, while the transition condition according to which the state in the state machine makes a predetermined transition is satisfied, the state in the single state machine transitions to another state corresponding to another state of all state machines that results from the predetermined transition.

### BRIEF DESCRIPTION OF THE DRAWINGS

FIG. 1 It is a block diagram depicting a structural example of Exemplary Embodiment 1 of a change planning system according to the present invention.

FIG. 2 It is an explanatory diagram depicting the concept of a state machine set.

FIG. 3 It is an explanatory diagram depicting an example of a textual definition of a state machine set.

FIG. 4 It is an explanatory diagram depicting an example of a definition of a transition condition using an OR condition.

FIG. 5 It is an explanatory diagram depicting an example of a definition of a transition condition using an AND condition.

FIG. 6 It is an explanatory diagram depicting an example of a state machine set conversion result.

FIG. 7 It is a flowchart depicting operation of a state machine set conversion process by a change planning system 100.

FIG. 8 It is a flowchart depicting operation of a state generation process and a transition generation process by the change planning system 100.

FIG. 9 It is an explanatory diagram depicting an example of a state and transition generation process.

FIG. 10 It is a flowchart depicting operation of a transition removal process by the change planning system 100.

FIG. 11 It is a block diagram depicting a structural example of Exemplary Embodiment 2 of a change planning system according to the present invention.

FIG. 12 It is an explanatory diagram depicting an example of a state machine set including parallelizable tasks.

FIG. 13 It is an explanatory diagram depicting an example of a transition order generation result as a totally ordered set.

FIG. 14 It is an explanatory diagram depicting an example of a transition order generation result as a partially ordered set.

FIG. 15 It is a flowchart depicting operation of a change planning process by the change planning system 100.

FIG. 16 It is a flowchart depicting operation of a transition order conversion process by a transition order conversion unit 103.

FIG. 17 It is a block diagram depicting a structural example of Exemplary Embodiment 3 of a change planning system according to the present invention.

FIG. 18 It is an explanatory diagram depicting an example of a simplifiable state machine set.

FIG. 19 It is an explanatory diagram depicting an example of a simplifiable state machine.

FIG. 20 It is a flowchart depicting operation of a change planning process by the change planning system 100.

FIG. 21 It is a flowchart depicting operation of a state machine set simplifying process by a state machine simplifying unit 104.

FIG. 22 It is a flowchart depicting operation of a process of determining a state machine having a possibility of transition induction by the state machine simplifying unit 104.

FIG. 23 It is a block diagram schematically depicting a change planning system according to the present invention.

### DESCRIPTION OF EXEMPLARY EMBODIMENT

### Exemplary Embodiment 1

### Structure

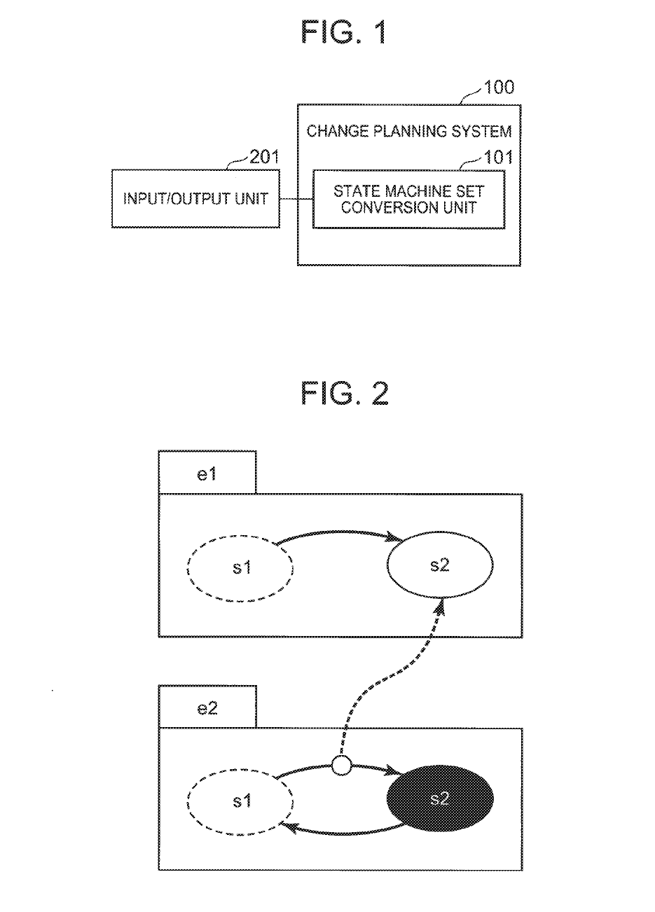

The following describes Exemplary Embodiment 1 of the present invention, with reference to drawings. FIG. 1 is a block diagram depicting a structural example of Exemplary Embodiment 1 of a change planning system according to the present invention. A change planning system 100 depicted in FIG. 1 includes a state machine set conversion unit 101.

The state machine set conversion unit 101 has a function of converting a state machine set made up of one or more state machines into a single state machine. The state machine set conversion unit 101 is connected with an input/output unit 201 located outside the change planning system 100 via a communication network or the like, so as to communicate with the input/output unit 201.

The state machine set conversion unit 101 receives a state machine set input via the input/output unit 201. The state machine set conversion unit 101 converts the received state machine set into a single state machine. The state machine set conversion unit 101 transmits the converted single state machine to the input/output unit 201.

The state machine set in this exemplary embodiment corresponds to a system to be managed and a change request for the system to be managed. The state machine set is made up of one or more state machines. Each state machine represents a component included in the system.

The state machine can have a plurality of states. A state can transition to another state in the same state machine. The state machine always has one current state, and can transition to any number (including 0) of desired states. In other words, the state machine includes a plurality of states.

In the case where a plurality of desired states are designated, the desired state of the state machine may be any of the designated states. In the case where no desired state is designated, the desired state of the state machine may be any state. A transition condition of a transition is designated according to a state in a state machine other than a state machine including the transition.

FIG. 2 is an explanatory diagram depicting the concept of a state machine set. In FIG. 2, the rectangles each represent a state machine. The ellipses each represent a state. The solid arrows each represent a transition. The dotted arrow represents a transition condition. The dotted ellipses each represent a current state. The black ellipse represents a desired state. The circle on the arrow of the transition represents the start point of the arrow of the transition condition. State machines and the like in other drawings are represented in the same way as in FIG. 2.

FIG. 2 depicts a state machine set made up of two state machines “e1” and “e2”. Each of “e1” and “e2” includes two states “s1” and “s2”.

As depicted in FIG. 2, “s1” in “e1” includes a transition to “s2”. Each of “s1” and “s2” in “e2” includes a transition to the other state. The transition from “s1” to “s2” in “e2” has the state “s2” of “e1” as a transition condition. Moreover, “e1” has “s1” as a current state, and “e2” has “s1” as a current state and “s2” as a desired state.

For example, the state “s1” of the state machine “e1” is hereafter denoted by “e1(s1)”, and the transition of the state machine “e1” from the state “s1” to the state “s2” is hereafter denoted by “e1(s1,s2)”, for sake of simplicity.

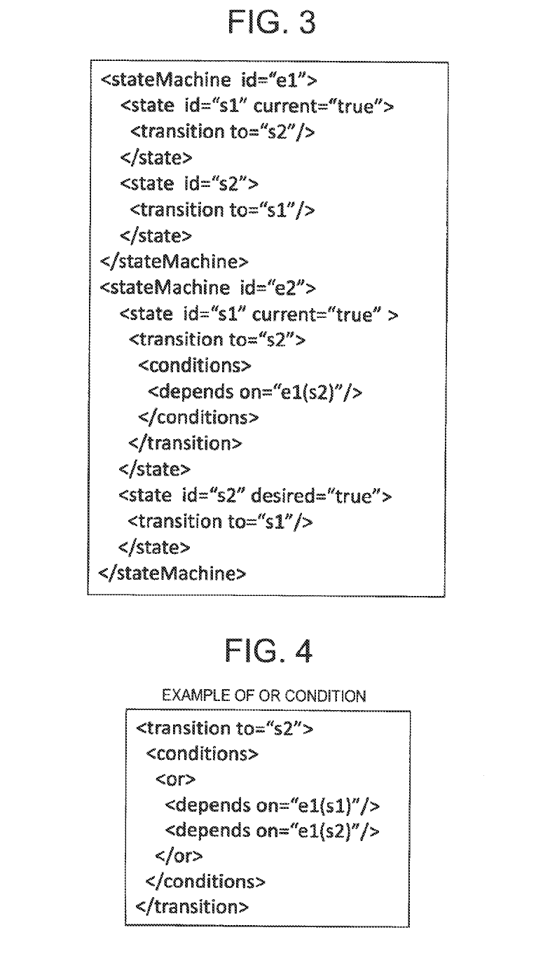

FIG. 3 is an explanatory diagram depicting an example of a textual definition of a state machine set. FIG. 3 depicts an example of the definition of the state machine set depicted in FIG. 2, as an example of representation using Extensible Markup Language (XML).

As depicted in FIG. 3, for example, each state machine is represented by a “stateMachine” tag. The ID of the state machine is represented by an “id” attribute of “stateMachine”. Each state of the state machine is represented by a “state” tag as a child element of the “stateMachine” tag. The ID of the state is represented by an “id” attribute of “state”.

As depicted in FIG. 3, the transition of the state is represented by a “transition” tag as a child element of the “state” tag. The ID indicating the state of the transition destination is represented by a “to” attribute of “transition”.

As depicted in FIG. 3, the transition condition of the transition is represented by a “conditions” tag as a child element of the “transition” tag. In the case where the transition has the state “s2” of the state machine “e1” as the transition condition, the transition condition is represented by describing a “depends” tag as a child element of the “conditions” tag and setting the “on” attribute of “depends” tag to “e1(s2)”. In the case where one transition has a plurality of transition conditions, the plurality of transition conditions are described using a plurality of “depends” tags as child elements of the “conditions” tag.

To set a more complex transition condition designating any of two or more states or designating all of two or more states simultaneously, for example, a transition condition concerning a plurality of states may be described as a child element of an “or” tag or an “and” tag.

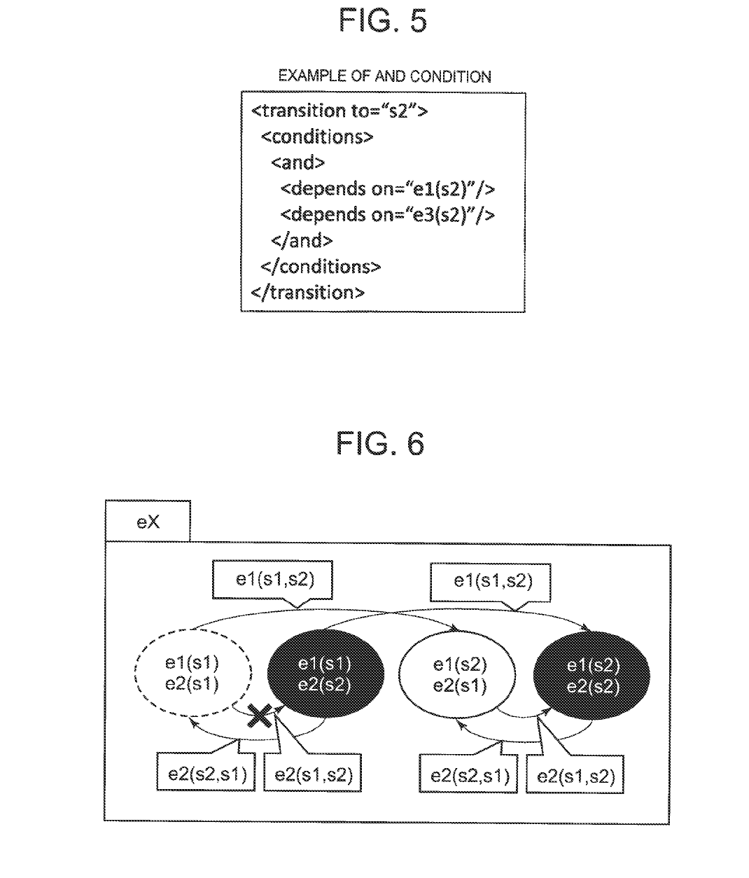

FIGS. 4 and 5 each depict an example of describing a transition condition concerning a plurality of states. FIG. 4 is an explanatory diagram depicting an example of a definition of a transition condition using an OR condition. FIG. 4 depicts that the transition condition is satisfied when the state machine “e1” is in the state “s1” or the state “s2”.

FIG. 5 is an explanatory diagram depicting an example of a definition of a transition condition using an AND condition. FIG. 5 depicts that the transition condition is satisfied when the state machine “e1” is in the state “s2” and the state machine “e3” is in the state “s2”.

A change plan for the system based on the state machine set in this exemplary embodiment can be generated by finding such transition order that enables all state machines in which the desired state is designated to transition from the current state to the desired state while constantly satisfying all transition conditions. In the example of the state machine set depicted in FIG. 2, the transition order “(e1(s1,s2), e2(s1,s2))” is the simplest single solution.

For a simple system made up of a small number of state machines, the transition order is easy to find. For a complex system including many state machines, states, states which transition, and transition conditions, however, the transition order is hard to find.

In view of this, the change planning system in this exemplary embodiment converts a plurality of state machines into a single state machine. The change planning system aims to facilitate finding the transition order by the conversion into a single state machine.

FIG. 6 is an explanatory diagram depicting an example of a state machine set conversion result. FIG. 6 depicts the result of converting the state machine set depicted in FIG. 2 into a single state machine “eX”. The states in the state machine after the conversion are made up of all combinations of the states of all state machines before the conversion.

As depicted in FIG. 2, the state machine set before the conversion includes two state machines “e1” and “e2”, and each of “e1” and “e2” includes two states “s1” and “s2”.

As depicted in FIG. 6, the state machine “eX” after the conversion includes four states “e1(s1),e2(s1)”, “e1(s1),e2(s2)”, “e1(s2),e2(s1)”, and “e1(s2),e2(s2)”. For example, the state in which the “e1” element is “s1” and the “e2” element is “s1” is hereafter denoted by “e1(s1),e2(s1)”.

Suppose the state machine set before the conversion further includes a state machine “e3”, and “e3” includes three states “s1”, “s2”, and “s3”. In such a case, the state machine “eX” includes a total of 12 states obtained by combining each of the above-mentioned four states with each of “e3(s1)”, “e3(s2)”, and “e3(s3)”.

Moreover, the states in the state machine after the conversion include transitions and transitions according to transition conditions included in the state machines before the conversion. In the example depicted in FIG. 6, the state machine “eX” includes the transition from “e1(s1),e2(s1)” to “e1(s2),e2(s1)” and the transition from “e1(s1),e2(s2)” to “e1(s2),e2(s2)”, as the transitions deriving from the transition “e1(s1,s2)” included in the state machine before the conversion.

In detail, on the basis of the transition “e1(s1,s2)” included in the state machine before the conversion, the state machine set conversion unit 101 generates the transitions from all states in which the “e1” element is “s1” among the states in the state machine “eX” to the corresponding states in which the “e1” element is changed from “s1” to “s2” while the element other than “e1” is unchanged. The upper word balloons depicted in FIG. 6 indicate that the respective transitions derive from the transition “e1(s1,s2)”.

Likewise, the state machine set conversion unit 101 tries to generate the transition from “e1(s1),e2(s1)” to “e1(s1),e2(s2)” and the transition from “e1(s2),e2(s1)” to “e1(s2),e2(s2)”, as the transitions deriving from the transition “e2(s1,s2)” included in the state machine before the conversion.

Likewise, the state machine set conversion unit 101 tries to generate the transition from “e1(s1),e2(s2)” to “e1(s1),e2(s1)” and the transition from “e1(s2),e2(s2)” to “e1(s2),e2(s1)”, as the transitions deriving from the transition “e2(s2,s1)” included in the state machine before the conversion.

In other words, the state machine set conversion unit 101 tries to generate two transitions from one state to the other state and vice versa, between “e1(s1),e2(s1)” and “e1(s1),e2(s2)” and between “e1(s2),e2(s1)” and “e1(s2),e2(s2)”.

However, the transition “e1(s1),e2(s1)” to “e1(s1),e2(s2)” ends up being not generated, for the following reason. The transition “e2(s1,s2)” included in the state machine before the conversion complies with the transition condition designating the state “e1(s2)”. Therefore, even when the state machine set conversion unit 101 tries to generate the transition from “e1(s1),e2(s1)” to “e1(s1),e2(s2)”, the transition is not generated because the “e1” element in the transition source state “e1(s1),e2(s1)” does not satisfy the transition condition.

The lower word balloons depicted in FIG. 6 indicate that the respective transitions derive from any of the transition “e2(s1,s2)” and the transition “e2(s2,s1)”. Since the transition from “e1(s1),e2(s1)” to “e1(s1),e2(s2)” is not generated as mentioned above, the corresponding arrow is marked with “x”.

The current state in the state machine after the conversion is determined by the combination of the current states in all state machines before the conversion. In the state machine set depicted in FIG. 2, the state “e1(s1)” and the state “e2(s1)” are the respective current states. The state “e1(s1),e2(s1)” obtained by combining these current states is the current state of the state machine “eX”, as depicted in FIG. 6.

The desired state in the state machine after the conversion is determined basically in the same way as the current state. The desired state, however, might not be designated in the state machine before the conversion. Accordingly, every state that includes, as an element, the state in the state machine before the conversion designated as the desired state and satisfies the designated desired state is the desired state in the state machine after the conversion. Hence, there is a possibility that a plurality of desired states are generated.

In the state machine set depicted in FIG. 2, only “e2(s2)” is designated as the desired state. The two states “e1(s1),e2(s2)” and “e1(s2),e2(s2)” in which the “e2” element is “s2” are accordingly the desired states of the state machine “eX”, as depicted in FIG. 6.

The transition order from the current state to the desired state in the single state machine is found by a widely known shortest path search algorithm. In the example depicted in FIG. 6, the transition order made up of the transition from “e1(s1),e2(s1)” to “e1(s2),e2(s1)” and the transition from “e1(s2),e2(s1)” to “e1(s2),e2(s2)” is derived.

By referencing the transitions included in the state machines before the conversion from which the transitions constituting the derived transition order derive, the transition order “(e1(s1,s2), e2(s1,s2))” is derived eventually. The change plan is generated as a result of deriving the transition order.

The state machine set conversion unit 101 in this exemplary embodiment is, for example, realized by a central processing unit (CPU) executing processes according to control of a program stored in a non-transitory computer-readable recording medium.

[Operation]

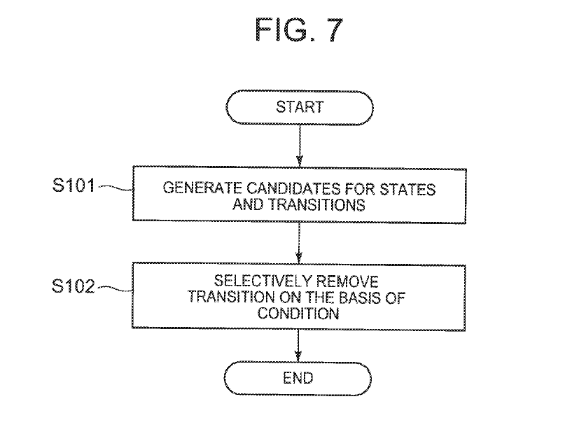

The following describes the operation of the change planning system 100 in this exemplary embodiment, with reference to FIG. 7. FIG. 7 is a flowchart depicting operation of a state machine set conversion process by the change planning system 100.

The state machine set conversion unit 101 receives a state machine set input via the input/output unit 201. The state machine set conversion unit 101 generates candidates for states and transitions included in a state machine after conversion, with reference to the received state machine set (step S101).

In step S101, the state machine set conversion unit 101 acquires the state machines from the received state machine set one by one. The state machine set conversion unit 101 combines each state and transition in a single state machine as a provisional result with each state and transition in the acquired state machine, to generate the single state machine as the new provisional result including new states and transitions. The state machine set conversion unit 101 repeatedly performs the generation process on the basis of each state machine included in the state machine set.

The state machine set conversion unit 101 then checks a transition condition to be complied with by each generated transition. The state machine set conversion unit 101 removes each transition that does not satisfy the transition condition from among the generated transitions (step S102).

In step S102, the state machine set conversion unit 101 acquires the generated states from the result obtained in step S101, one by one. The state machine set conversion unit 101 checks a transition condition to be complied with by each transition held by the acquired state.

If any element of the acquired state does not satisfy the checked transition condition, the state machine set conversion unit 101 removes the transition that is to comply with the transition condition. The state machine set conversion unit 101 repeatedly performs the removal process on each transition held by the acquired state. After removing the transition, the state machine set conversion unit 101 ends the process.

The following describes the process in each step of the flowchart depicted in FIG. 7 in detail.

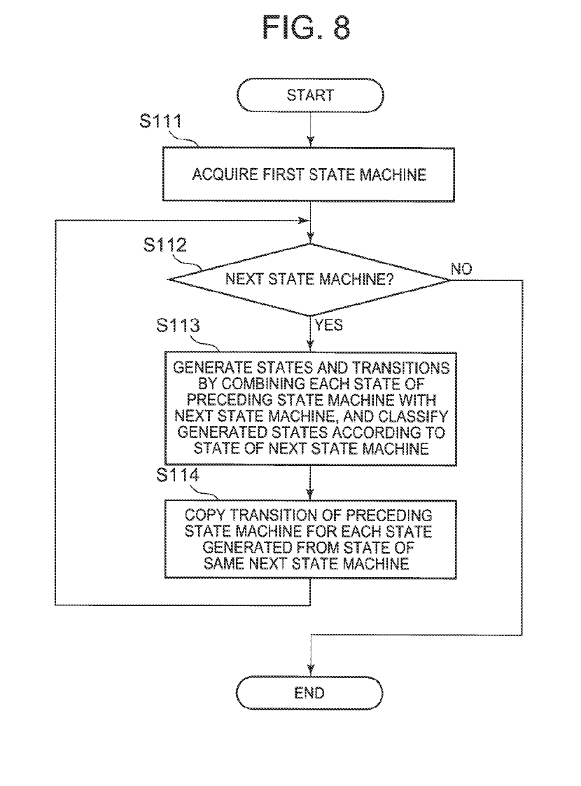

The process in step S101 is described in detail below, with reference to FIG. 8. FIG. 8 is a flowchart depicting operation of a state generation process and a transition generation process by the change planning system 100.

The state machine set conversion unit 101 includes each state and transition in a state machine acquired first from the state machine set, in the single state machine as the provisional result (step S111). Here, the state machine set conversion unit 101 includes, in the states in the single state machine as the provisional result, the states in the acquired state machine each as an element of the acquired state machine.

For example, in the case where the state machine acquired first is “e1” and “e1” includes the states “s1” and “s2”, the following two states are generated in the single state machine as the provisional result: the state “e1(s1)” in which the “e1” element is “s1”; and the state “e1(s2)” in which the “e1” element is “s2”. The generated states include a transition relating to “s1” and “s2” in “e1”.

The state machine set conversion unit 101 then determines whether or not any unprocessed state machine is included in the received state machine set (step S112).

In the case where no unprocessed state machine is included (step S112: No), the state machine set conversion unit 101 sets the obtained provisional result as the final result, and ends the process.

In the case where any unprocessed state machine is included (step S112: Yes), the state machine set conversion unit 101 acquires an unprocessed state machine to be processed next. The state machine set conversion unit 101 adds, as an element, each state in the acquired state machine to each state in the single state machine as the provisional result, thus generating new states and transitions (step S113).

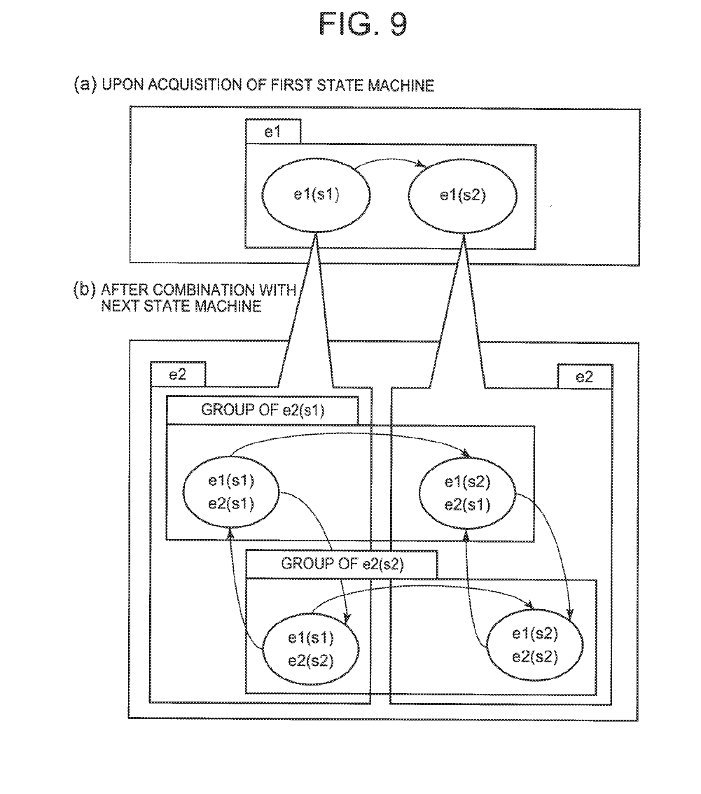

FIG. 9 depicts an example of a detailed process of generating new states and transitions in step S113. FIG. 9 is an explanatory diagram depicting an example of a state and transition generation process.

The example depicted in FIG. 9 corresponds to the state machine set depicted in FIG. 2. FIG. 9 depicts a situation where each state and transition of “e1” are included in the single state machine as the provisional result and the provisional result is combined with each state and transition of “e2”.

In the combining process, the state machine set conversion unit 101 first extracts the states of the single state machine as the provisional result, one by one. Following this, in the process relating to the extracted state, the state machine set conversion unit 101 extracts the states of the state machine to be combined, one by one.

As depicted in FIG. 9(a), the single state machine as the provisional result has two states “e1(s1)” and “e1(s2)”. Meanwhile, the state machine “e2” to be combined has two states “s1” and “s2”.

The state machine set conversion unit 101 first extracts “e1(s1)” from the single state machine as the provisional result. For the extracted “e1(s1)”, the state machine set conversion unit 101 extracts the states “s1” and “s2” of “e2” one by one. The state machine set conversion unit 101 then generates a new state by adding, to the state extracted from the single state machine as the provisional result, the element of the state machine including the state to be combined.

For example, in the case where the state “s1” of the state machine “e2” is extracted for “e1(s1)”, the state machine set conversion unit 101 generates the new state “e1(s1),e2(s1)”. In the case where the state “s2” of the state machine “e2” is extracted for “e1(s1)”, the state machine set conversion unit 101 generates the new state “e1(s1),e2(s2)”.

Having generated the new state, the state machine set conversion unit 101 records the new state so as to be readable in a memory of a group that differs according to the state in the state machine to be combined. For example, the state machine set conversion unit 101 records “e1(s1),e2(s1)” in the group of “e2(s1)”, and records “e1(s1),e2(s2)” in the group of “e2(s2)”, as depicted in FIG. 9(b).

The state machine set conversion unit 101 repeatedly performs the above-mentioned process on each state of the state machine to be combined. Having generated all new states from the specific state of the single state machine as the provisional result, the state machine set conversion unit 101 further adds, to each generated state, the same transition as the transition held by each state of the state machine to be combined.

For example, the state machine set conversion unit 101 adds the transition to each of the generated two new states “e1(s1),e2(s1)” and “e1(s1),e2(s2)” so that the two new states have the same transition relationship as the transition relationship between “s1” and “s2” of “e2”. The state machine set conversion unit 101 repeatedly performs the above-mentioned process on each state of the single state machine as the provisional result.

In the stage when the transition is added, the new states derived from all states of the single state machine as the provisional result have been recorded in all groups generated for the respective states in the state machine to be combined. The state machine set conversion unit 101 extracts the recorded states from each group one by one, and adds, to the state in the group, the same transition as the transition held by the state in the single state machine as the provisional result.

For example, the state machine set conversion unit 101 adds, to “e1(s1),e2(s1)”, the transition to “e1(s2),e2(s1)” so that the states “e1(s1),e2(s1)” and “e1(s2),e2(s1)” in the group of “e2(s1)” have the same transition as the transition between the states “e1(s1)” and “e1(s2)” in the single state machine as the provisional result. The state machine set conversion unit 101 repeatedly performs the above-mentioned process on each group (step S114).

The state machine set conversion unit 101 sets the result obtained as a result of completing the process in step S114, as the new provisional result. After generating the new provisional result, the state machine set conversion unit 101 performs the process in step S112 again.

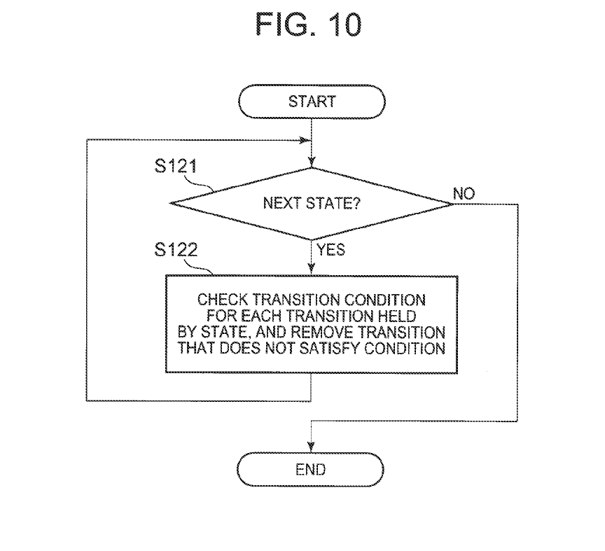

The process in step S102 is described in detail below, with reference to FIG. 10. FIG. 10 is a flowchart depicting operation of a transition removal process by the change planning system 100.

The state machine set conversion unit 101 determines whether or not any state unprocessed with regard to transition removal is included in the result generated in step S101 (step S121).

In the case where any unprocessed state is included (step S121: Yes), the state machine set conversion unit 101 checks a transition condition to be complied with by each transition held by the unprocessed state. If any element in the unprocessed state does not satisfy the transition condition, the state machine set conversion unit 101 removes the transition that is to comply with the checked transition condition (step S122).

As an example, suppose “e1(s2),e2(s1)” depicted in FIG. 9(b) is acquired as an unprocessed state. Here, “e1(s2),e2(s1)” includes the transition to “e1(s2),e2(s2)”, and the included transition is to comply with the transition condition designating “e1(s2)”.

The state machine set conversion unit 101 accordingly checks whether or not the “e1” element of the state is “s2”. Since the “e1” element of “e1(s2),e2(s1)” is “s2” as a result of the check, the state machine set conversion unit 101 maintains the transition that is to comply with the transition condition designating “e1(s2)”.

As another example, suppose “e1(s1),e2(s1)” depicted in FIG. 9(b) is acquired as an unprocessed state. Here, “e1(s1),e2(s1)” includes the transition to “e1(s1),e2(s2)”, and the included transition is to comply with the transition condition designating “e1(s2)”.

The state machine set conversion unit 101 accordingly checks whether or not the “e1” element of the state is “s2”. Since the “e1” element of “e1(s1),e2(s1)” is “s1” as a result of the check, the state machine set conversion unit 101 removes the transition that is to comply with the transition condition designating “e1(s2)”.

In the case where there is no unprocessed state with regard to transition removal (step S121: No), the state machine set conversion unit 101 ends the process. As a result of the above-mentioned processes, the change planning system 100 generates, for example, the state machine “eX” depicted in FIG. 6.

[Advantageous Effects]

The change planning system in this exemplary embodiment can express definition information about components, dependence, and operations represented by a plurality of state machines and transition conditions between state machines, as a single state machine. From the single state machine, the operation procedure can be derived by a widely known shortest path search algorithm. The operation procedure can thus be derived by a very efficient computation procedure.

Moreover, the change planning system in this exemplary embodiment can use simple task definitions having high reusability because the intended system is made up of a plurality of state machines. The change planning system in this exemplary embodiment can also generate a change plan in which one component reaches a desired state through a plurality of temporary states.

### Exemplary Embodiment 2

### Structure

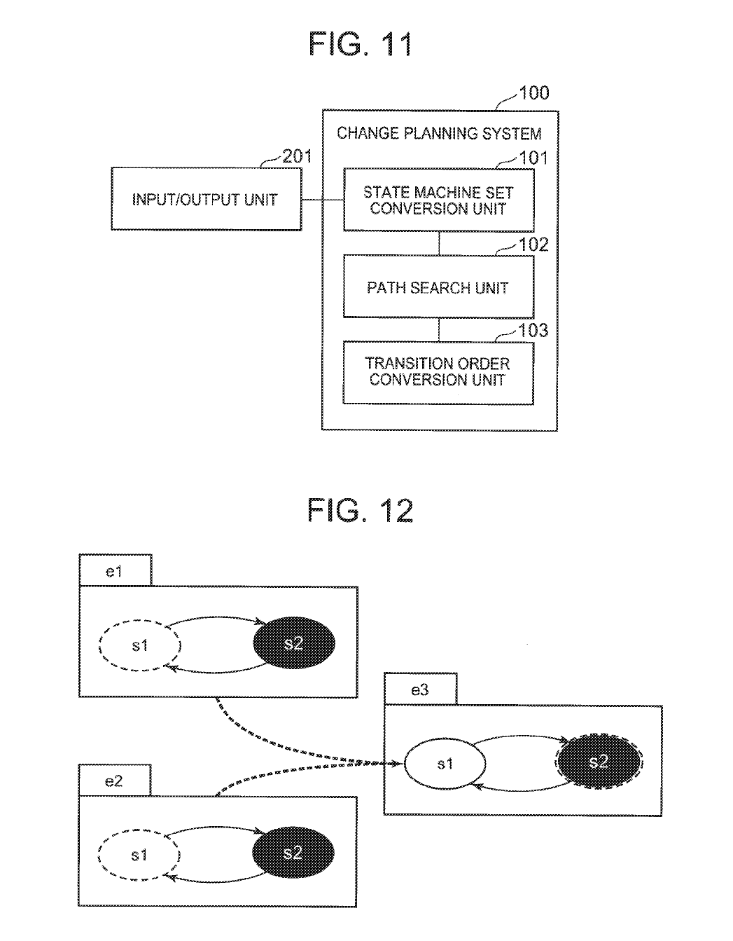

The following describes Exemplary Embodiment 2 of the present invention, with reference to drawings. FIG. 11 is a block diagram depicting a structural example of Exemplary Embodiment 2 of a change planning system according to the present invention. In FIG. 11, the same structural elements as those in Exemplary Embodiment 1 are given the same reference signs, and their description is omitted.

The change planning system 100 depicted in FIG. 11 includes the state machine set conversion unit 101, a path search unit 102, and a transition order conversion unit 103.

The path search unit 102 has a function of finding a transition path in a state machine made up of a set of one or more transitions for causing the state machine to transition from one state to another state. The path search unit 102 is connected with each of the state machine set conversion unit 101 and the transition order conversion unit 103 via a communication network or the like, so as to communicate with each of the state machine set conversion unit 101 and the transition order conversion unit 103.

The transition order conversion unit 103 has a function of converting a transition set constituting a path, into a partially ordered set of transitions in which ordering is provided only between transitions included in any pair of state machines associated by a transition condition.

A partially ordered set is an ordered set in which some pair of elements between which no ordering is specified are included in the elements of the set. In comparison with a partially ordered set, a totally ordered set is an ordered set in which ordering is specified between every pair of the elements of the set.

The state machine set conversion unit 101 in this exemplary embodiment converts a state machine set received from the input/output unit 201, into a single state machine. The state machine set conversion unit 101 supplies the converted single state machine to the path search unit 102.

The path search unit 102 generates transition order as a totally ordered set, on the basis of the single state machine received from the state machine set conversion unit 101.

For example, the path search unit 102 generates the transition order on the basis of a widely known shortest path search algorithm using Dijkstra's algorithm. In the case of generating the transition order on the basis of the shortest path search algorithm, the path search unit 102 maps the state machine as a graph in which each state is a node and each transition is an edge.

The path search unit 102 successively computes the shortest distance and the shortest path from the current state to each state, on the basis of the mapped graph. After the computation, the path search unit 102 detects the shortest path to a desired state that can be reached with the shortest distance from among a plurality of desired states.

The path search unit 102 arranges the transitions constituting the detected shortest path in order, and outputs, as transition order, information associating each arranged transition with dependence on its immediately preceding transition. The path search unit 102 supplies the generated transition order to the transition order conversion unit 103.

The transition order conversion unit 103 converts the transition order as the totally ordered set received from the path search unit 102, into transition order as a partially ordered set. The transition order conversion unit 103 returns the converted transition order as the partially ordered set, to the path search unit 102.

The path search unit 102 returns the transition order as the partially ordered set received from the transition order conversion unit 103, to the state machine set conversion unit 101. The state machine set conversion unit 101 returns the transition order received from the path search unit 102, to the input/output unit 201.

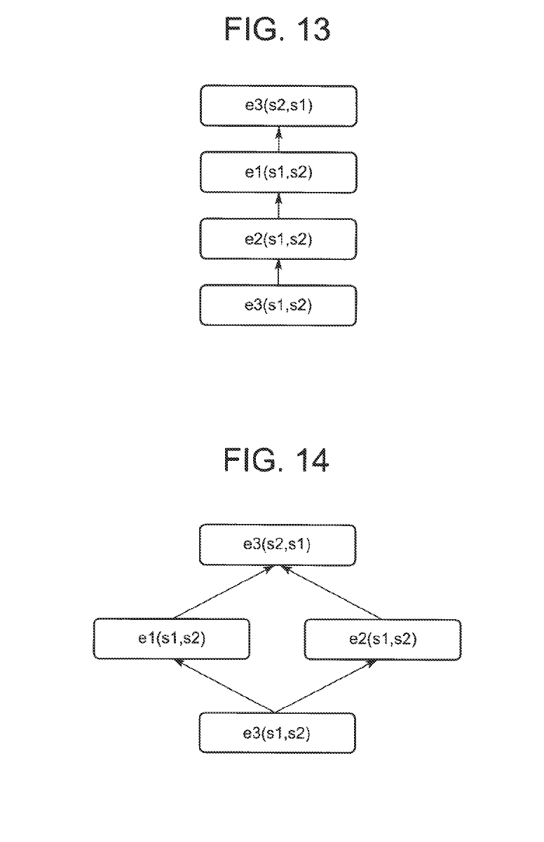

FIG. 12 is an explanatory diagram depicting an example of a state machine set including parallelizable tasks. FIG. 13 depicts an example of transition order generated by the state machine set conversion unit 101 and the path search unit 102 on the basis of the state machine set depicted in FIG. 12. FIG. 13 is an explanatory diagram depicting an example of a transition order generation result as a totally ordered set.

In FIG. 13, the rounded-corner rectangles each represent a transition. The arrows between the transitions each represent the dependence between the transitions. Each transition is properly performed on the basis of the transition order depicted in FIG. 13.

In the case of performing each transition on the basis of the transition order depicted in FIG. 13, however, there is a problem in that, even when two or more processors for performing transitions are available, a plurality of transitions which are supposed to be able to be performed in parallel by these processors cannot be performed in parallel.

No transition condition is designated between state machines “e1” and “e2” depicted in FIG. 12. In other words, no dependence needs to be designated between “e1(s1,s2)” which is a transition in “e1” and “e2(s1,s2)” which is a transition in “e2”.

FIG. 14 depicts transition order as a partially ordered set obtained by converting the transition order as the totally ordered set depicted in FIG. 13, on the basis of the above-mentioned point. FIG. 14 is an explanatory diagram depicting an example of a transition order generation result as a partially ordered set.

In the case of performing each transition on the basis of the transition order depicted in FIG. 14, “e1(s1,s2)” and “e2(s1,s2)” may be performed in parallel. Therefore, when two or more processors are available, all transitions are performed faster than in the case of performing each transition on the basis of the transition order as the totally ordered set.

The transition order conversion unit 103 removes dependence corresponding to dependence between state machines between which no transition condition is designated, from the transition order as the totally ordered set. The transition order conversion unit 103 also adds dependence corresponding to correct dependence between state machines, to the transition order as the totally ordered set. The transition order conversion unit 103 thus generates the transition order as the partially ordered set.

The path search unit 102 and the transition order conversion unit 103 in this exemplary embodiment are, for example, realized by a central processing unit (CPU) executing processes according to control of a program stored in a non-transitory computer-readable recording medium.

[Operation]

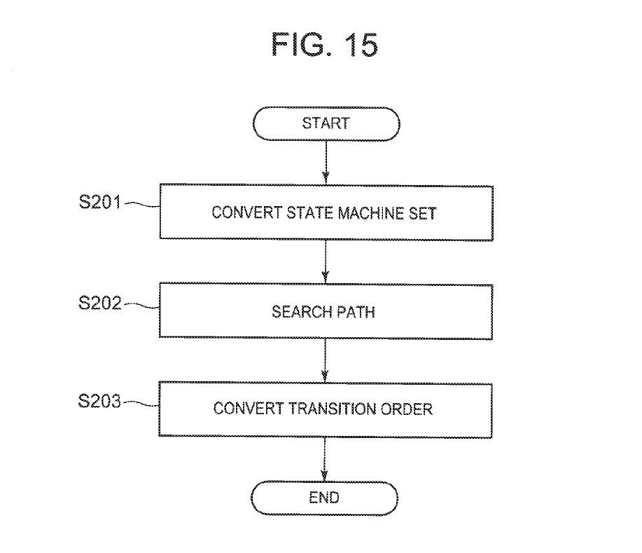

The following describes the operation of the change planning system 100 in this exemplary embodiment, with reference to FIG. 15. FIG. 15 is a flowchart depicting operation of a change planning process by the change planning system 100.

The state machine set conversion unit 101 receives information of a state machine set via the input/output unit 201. The state machine set conversion unit 101 converts the state machine set indicated by the received information, into a single state machine (step S201).

The state machine set conversion unit 101 supplies the converted single state machine to the path search unit 102. The path search unit 102 generates transition order as a totally ordered set, from the received single state machine (step S202).

The path search unit 102 supplies the generated transition order to the transition order conversion unit 103. The transition order conversion unit 103 converts the received transition order into transition order as a partially ordered set. The transition order conversion unit 103 returns the converted transition order to the path search unit 102 (step S203).

The path search unit 102 returns the transition order received from the transition order conversion unit 103, to the state machine set conversion unit 101. The state machine set conversion unit 101 transmits the received transition order to the input/output unit 201. After the transmission, the change planning system 100 ends the overall change planning process.

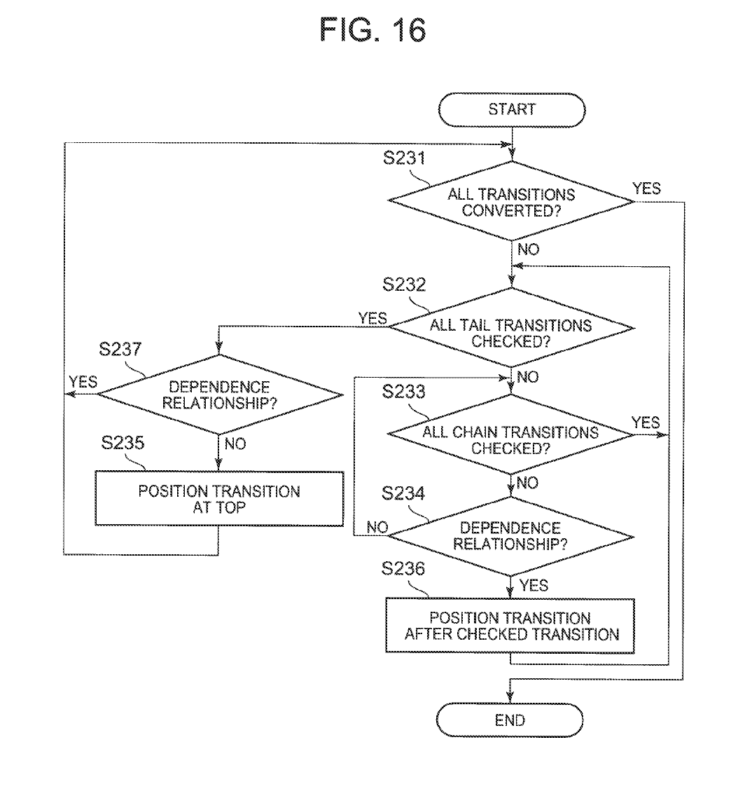

The process in step S203 is described in detail below, with reference to FIG. 16. FIG. 16 is a flowchart depicting operation of a transition order conversion process by the transition order conversion unit 103.

In step S203, the transition order conversion unit 103 acquires, one by one, the transitions in the transition order as the totally ordered set received from the path search unit 102, according to the transition order. The transition order conversion unit 103 repositions the acquired transition in transition order as a partially ordered set which is a provisional result. The transition order conversion unit 103 repeatedly performs the repositioning process on each transition in the received transition order. Note that the provisional result initially includes no information.

The transition order conversion unit 103 determines whether or not all transitions in the received transition order have been converted (step S231). In the case where all transitions have been converted (step S231: Yes), the transition order conversion unit 103 sets the obtained provisional result as the final result, and ends the conversion process.

In the case where all transitions have not been converted (step S231: No), the transition order conversion unit 103 acquires one unconverted transition. The transition order conversion unit 103 places the acquired transition in an appropriate position in the transition order as the current provisional result.

To determine the appropriate position in the transition order as the current provisional result in which the acquired transition is to be placed, the transition order conversion unit 103 acquires all tail transitions on which no other transition is dependent, from among the transitions in the transition order as the provisional result. The transition order conversion unit 103 checks the relationship between each acquired tail transition and the transition to be repositioned. The transition order conversion unit 103 thus repeatedly performs the relationship check process on each acquired tail transition.

The reason for acquiring the tail transition is to prevent generation of unnecessary ordering. For example, suppose two transitions “A” and “B” are included in the transition order as the provisional result, and “B” is dependent on “A”. This is a situation where the transitions are induced in the order of “A, B”. Also suppose “C” is a transition to be repositioned next, and is dependent on each of the transitions “A” and “B”.

In the case of newly generating transition order made up of “A”, “B”, and “C”, dependence only needs to be designated between “C” and “B”. It is redundant to designate dependence between “C” and “A”.

This is because, since it is ensured that “B” is induced after “A”, “C” is always induced after “A” so long as it is ensured that “C” is induced after “B”. A situation where it is ensured that “C” is induced after “B” is equivalent to a situation where dependence is designated between “C” and “A”.

Hence, upon repositioning “C” in the above-mentioned example, the transition order conversion unit 103 first checks the relationship between “C” and “B”. In the case of determining that “C” is dependent on “B”, the transition order conversion unit 103 does not check the relationship between “C” and any other transition on which “B” is dependent.

The transition order conversion unit 103 determines whether or not all acquired tail transitions have been checked (step S232).

In the case where all acquired tail transitions have not been checked (step S232: No), the transition order conversion unit 103 acquires one unchecked tail transition. The transition order conversion unit 103 then acquires a series of transitions following the acquired tail transition, one by one. The transition order conversion unit 103 checks the relationship between the acquired transition and the transition to be repositioned. The transition order conversion unit 103 repeatedly performs the check process on each acquired transition.

The transition order conversion unit 103 may sequentially acquire the series of transitions following the tail transition, by depth-first search. In the case of determining that the transition to be repositioned is dependent on the acquired transition, the transition order conversion unit 103 does not search for any other transition on which the acquired transition is dependent.

The transition order conversion unit 103 also sequentially records the checked transitions so that the same transition is not checked more than once for the same transition to be repositioned. The transition order conversion unit 103 does not check any transition recorded as already checked, and any transition on which the transition recorded as already checked is dependent.

To carry out the above-mentioned process, the transition order conversion unit 103 determines whether or not the series of transitions following the acquired tail transition have all been checked (step S233). In the case where all of the transitions have been checked (step S233: Yes), the transition order conversion unit 103 performs the process in step S232 again, to process the next tail transition.

In the case where all of the transitions have not been checked (step S233: No), the transition order conversion unit 103 acquires the next transition following the acquired transition. The transition order conversion unit 103 checks the relationship between the acquired transition and the transition to be repositioned (step S234).

Whether or not the two transitions have a dependence relationship or an order relationship is determined on the basis of whether or not there is a transition condition that is to be complied with by one transition included in a state machine and that designates a state in a state machine including the other transition. In the case where the transition condition is present, the two transitions are determined as having a dependence relationship. In the case where the transition condition is not present, the two transitions are determined as having no dependence relationship.

In the example depicted in FIGS. 12 and 13, a transition condition is present between the state machines “e3” and “e1”, so that the two transitions “e3(s2,s1)” and “e1(s1,s2)” are determined as having a dependence relationship. On the other hand, no transition condition is present between the state machines “e1” and “e2”, so that the two transitions “e1(s1,s2)” and “e2(s1,s2)” are determined as having no dependence relationship.

In the case of determining that the transition to be repositioned and the transition to be checked have a dependence relationship (step S234: Yes), the transition order conversion unit 103 positions the transition to be repositioned, after the transition to be checked (step S236). By positioning the transition to be repositioned after the transition to be checked, the transition order conversion unit 103 sets the dependence on the transition to be checked, in the transition to be repositioned.

After positioning the transition to be repositioned, the transition order conversion unit 103 performs the process in step S232 again, to process the next tail transition.

In the case of determining that the transition to be repositioned and the transition to be checked have no dependence relationship (step S234: No), the transition order conversion unit 103 performs the process in step S233 again, to check the relationship between the transition to be repositioned and the next transition on which the transition to be checked is dependent.

In the case where no dependence relationship with any transition is found (step S237: No) as a result of checking all acquired tail transitions (step S232: Yes), the transition order conversion unit 103 positions the current transition to be repositioned, at the top of the transition order as a transition not dependent on any transition in the transition order as the provisional result (step S235). After the positioning, the transition order conversion unit 103 ends the check for the transition to be repositioned, and performs the process in step S231 again.

In the case where a dependence relationship with a transition is found (step S237: Yes), the transition order conversion unit 103 ends the check for the transition to be repositioned, and performs the process in step S231 again.

As an example, consider the case of converting the transition order as the totally ordered set depicted in FIG. 13 into the transition order as the partially ordered set depicted in FIG. 14, on the basis of the state machine set depicted in FIG. 12.

The transition order conversion unit 103 acquires the transition “e3(s2,s1)” at the top of the transition order. Since there is no transition to be compared in the provisional result, the transition order conversion unit 103 positions “e3(s2,s1)” at the top.

Next, the transition order conversion unit 103 acquires “e1(s1,s2)”. The transition order conversion unit 103 checks the relationship between the acquired “e1(s1,s2)” and “e3(s2,s1)” in the provisional result.

Since a transition condition is present between “e1” and “e3” as a result of the check, the transition order conversion unit 103 positions “e1(s1,s2)” after “e3(s2,s1)” in the provisional result.

Next, the transition order conversion unit 103 acquires “e2(s1,s2)”. The transition order conversion unit 103 checks the relationship between the acquired “e2(s1,s2)” and each transition in the provisional result.

The transition order conversion unit 103 checks the relationship between the acquired “e2(s1,s2)” and “e1(s1,s2)” which is the only transition on which no transition is dependent in the provisional result. Since no transition condition is present between “e2” and “e1” as a result of the check, the transition order conversion unit 103 does not position “e2(s1,s2)” after “e1(s1,s2)” in the provisional result.

The transition order conversion unit 103 then checks the relationship between the acquired “e2(s1,s2)” and “e3(s2,s1)” on which “e1(s1,s2)” is dependent. Since a transition condition is present between “e2” and “e3” as a result of the check, the transition order conversion unit 103 positions “e2(s1,s2)” after “e3(s2,s1)”.

Next, the transition order conversion unit 103 acquires “e3(s1,s2)”. The transition order conversion unit 103 checks the relationship between the acquired “e3(s1,s2)” and each of the transitions “e1(s1,s2)” and “e2(s1,s2)” on which no transition is dependent in the provisional result.

Since a transition condition is present between “e3” and “e1” and also a transition condition is present between “e3” and “e2” as a result of the check, the transition order conversion unit 103 positions “e3(s1,s2)” after both “e1(s1,s2)” and “e2(s1,s2)”.

[Advantageous Effects]

The change planning system in this exemplary embodiment can generate an operation procedure that enables simultaneous execution of operations, from definition information about components, dependence, and operations represented by a plurality of state machines and transition conditions between state machines.

### Exemplary Embodiment 3

### Structure

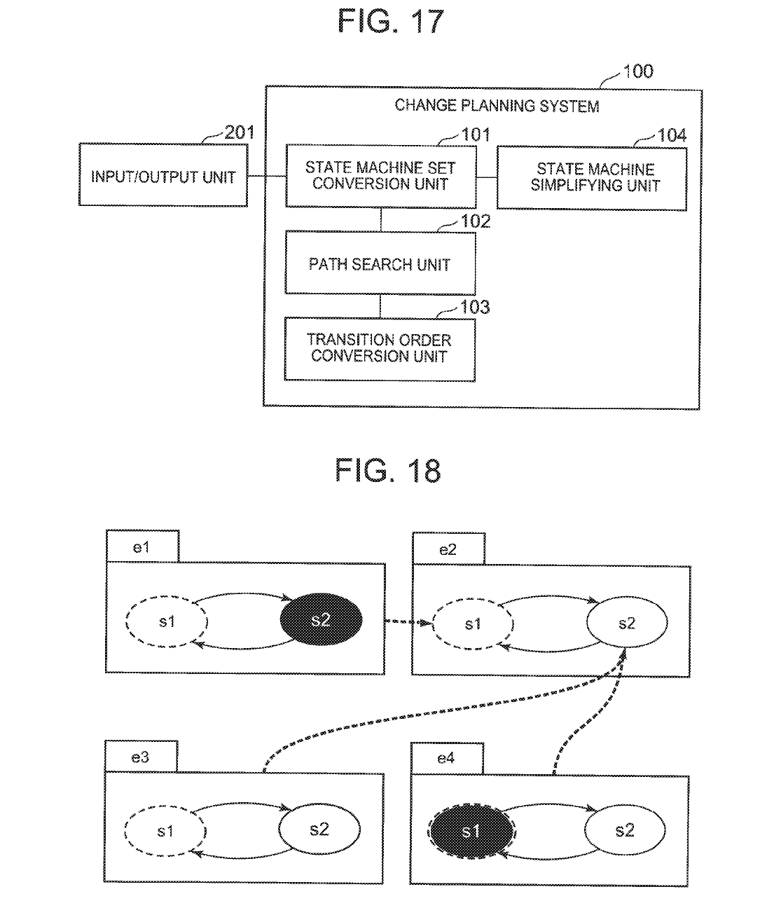

The following describes Exemplary Embodiment 3 of the present invention, with reference to drawings. FIG. 17 is a block diagram depicting a structural example of Exemplary Embodiment 3 of a change planning system according to the present invention. In FIG. 17, the same structural elements as those in Exemplary Embodiment 2 are given the same reference signs, and their description is omitted.

The change planning system 100 depicted in FIG. 17 includes the state machine set conversion unit 101, the path search unit 102, the transition order conversion unit 103, and a state machine simplifying unit 104.

The state machine simplifying unit 104 has a function of specifying a state machine in which no transition is induced, and removing the specified state machine and a transition condition relating to the specified state machine. The state machine simplifying unit 104 is connected with the state machine set conversion unit 101 via a communication network or the like, so as to communicate with the state machine set conversion unit 101.

The state machine set conversion unit 101 in this exemplary embodiment supplies information of a state machine set received from the input/output unit 201, to the state machine simplifying unit 104.

The state machine simplifying unit 104 simplifies the state machine set indicated by the received information. The state machine simplifying unit 104 returns the simplified state machine set to the state machine set conversion unit 101.

The state machine set conversion unit 101 converts the state machine set received from the state machine simplifying unit 104, into a single state machine. The state machine set conversion unit 101 supplies the converted single state machine to the state machine simplifying unit 104.

The state machine simplifying unit 104 simplifies the received single state machine. The state machine simplifying unit 104 returns the simplified state machine to the state machine set conversion unit 101.

The state machine set conversion unit 101 supplies the state machine received from the state machine simplifying unit 104, to the path search unit 102. The state machine set conversion unit 101 then returns the transition order received from the path search unit 102, to the input/output unit 201.

FIG. 18 is an explanatory diagram depicting an example of a simplifiable state machine set. FIG. 18 depicts each arrow that corresponds to a transition condition designating, from a state machine itself, a state in another state machine, unlike FIG. 2. The arrow indicates that all transitions in the state machine have the same transition condition as the transition condition corresponding to the arrow.

The simplifiable state machine set in this exemplary embodiment is a state machine set including at least one state machine that is determined beforehand as having no transition induced therein, without undergoing the check by the state machine set conversion unit 101 and the path search unit 102.

The number of states in the state machine after the conversion by the state machine set conversion unit 101 increases exponentially as the number of state machines before the conversion increases. Besides, the computational effort of the path computation by the path search unit 102 increases significantly as the number of states to be computed increases.

It is therefore desirable to remove each state machine known beforehand as having no transition induced therein, before the state machine set conversion process by the state machine set conversion unit 101.

In this exemplary embodiment, it is determined that a transition is induced in the case where a desired state different from the current state is set in a state machine including the transition. It is also determined that a transition is induced in the case where a state different from the current state in a state machine including the transition is designated by a transition condition to be complied with by another transition that is induced.

In FIG. 18, “e3” has no desired state, and no transition condition is designated to “e3”. Accordingly, no transition included in “e3” is induced.

In FIG. 18, “e4” has a desired state, but the desired state is the same as the current state. Moreover, no transition condition is designated to “e4”. Accordingly, no transition included in “e4” is induced.

In FIG. 18, “e2” has no desired state, but a plurality of transition conditions are designated to “e2”. Of the designated transition conditions, the transition condition designated from “e1” relates to the current state of “e2”. In other words, the transition condition designated from “e1” induces no transition.

The respective transition conditions designated from “e3” and “e4” relate to a state other than the current state of “e2”. However, since the transitions included in “e3” and “e4” are determined as not being induced as mentioned above, the respective transition conditions designated from “e3” and “e4” induce no transition.

Hence, in the example depicted in FIG. 18, the state machines other than “e1” are all determined as simplifiable state machines in which no transition is induced.

In the case of determining such, the state machine simplifying unit 104 removes all of “e2” and the transition condition relating to “e2”, “e3” and the transition condition relating to “e3”, and “e4” and the transition condition relating to “e4”. After the removal, the state machine simplifying unit 104 returns the state machine set made up of only “e1”, to the state machine set conversion unit 101.

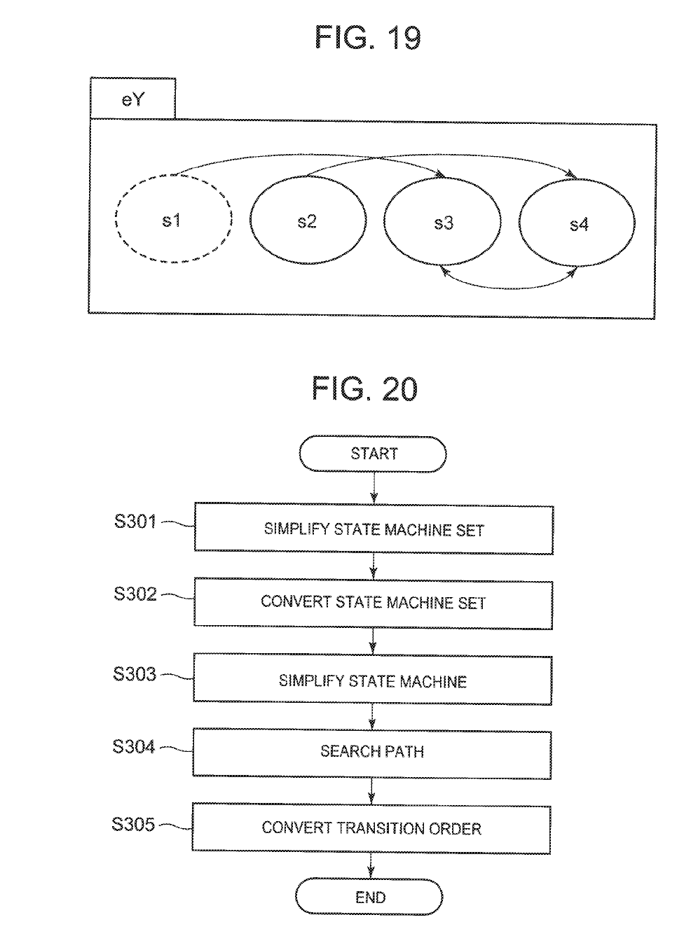

FIG. 19 is an explanatory diagram depicting an example of a simplifiable state machine. The simplifiable state machine in this exemplary embodiment is a state machine including at least one state to which no transition can be made from the current state.

In the case where widely known Dijkstra's algorithm or the like is used in the path search by the path search unit 102, the path search needs a computational time about the square of the number of states subjected to the path search.

It is therefore desirable to, if a state to which no transition can be made from the current state is determined in a short time, remove such an untransitionable state beforehand. The computation for determining each untransitionable state can be easily performed using widely known depth-first search or the like.

In the example depicted in FIG. 19, a state machine “eY” cannot transition from “s1” to “s2”. This is because no transition can be made to “s2” from any of “s3” and “s4” to which a transition can be made from “s1”.

In the case of receiving the state machine “eY” depicted in FIG. 19, the state machine simplifying unit 104 removes all of “s2” and the transition relating to “s2”. The state machine simplifying unit 104 returns the state machine “eY” including “s1”, “s3”, and “s4”, to the state machine set conversion unit 101.

The state machine simplifying unit 104 in this exemplary embodiment is, for example, realized by a central processing unit (CPU) executing processes according to control of a program stored in a non-transitory computer-readable recording medium.

[Operation]

The following describes the operation of the change planning system 100 in this exemplary embodiment, with reference to FIG. 20. FIG. 20 is a flowchart depicting operation of a change planning process by the change planning system 100.

The state machine set conversion unit 101 receives information of a state machine set via the input/output unit 201. The state machine set conversion unit 101 supplies the received information to the state machine simplifying unit 104.

The state machine simplifying unit 104 simplifies the state machine set indicated by the received information. The state machine simplifying unit 104 returns the simplified state machine set to the state machine set conversion unit 101 (step S301).

The state machine set conversion unit 101 converts the simplified state machine set received from the state machine simplifying unit 104, into a single state machine (step S302). The process in step S302 is the same as the process in step S201 in Exemplary Embodiment 2.

The state machine set conversion unit 101 supplies the converted single state machine to the state machine simplifying unit 104. The state machine simplifying unit 104 simplifies the received single state machine. The state machine simplifying unit 104 returns the simplified state machine to the state machine set conversion unit 101 (step S303).

In step S303, the state machine simplifying unit 104 simplifies the state machine using, for example, widely known graph traversal involving depth-first search.

In the case of using graph traversal, the state machine simplifying unit 104 maps the state machine as a graph in which each state is a node and each transition is an edge. Having mapped a graph, the state machine simplifying unit 104 detects all states to which the state machine can transition from the current state. After the detection, the state machine simplifying unit 104 removes each state determined as an untransitionable state and each transition relating to the determined state.

The state machine set conversion unit 101 supplies the state machine received from the state machine simplifying unit 104, to the path search unit 102.

The path search unit 102 generates transition order from the received state machine (step S304). The process in step S304 is the same as the process in step S202 in Exemplary Embodiment 2.

The path search unit 102 supplies the generated transition order to the transition order conversion unit 103. The transition order conversion unit 103 converts the received transition order into transition order as a partially ordered set (step S305). The process in step S305 is the same as the process in step S203 in Exemplary Embodiment 2.

The transition order conversion unit 103 returns the converted transition order to the path search unit 102. The path search unit 102 returns the transition order received from the transition order conversion unit 103, to the state machine set conversion unit 101. The state machine set conversion unit 101 transmits the received transition order to the input/output unit 201. The change planning system 100 then ends the overall change planning process.

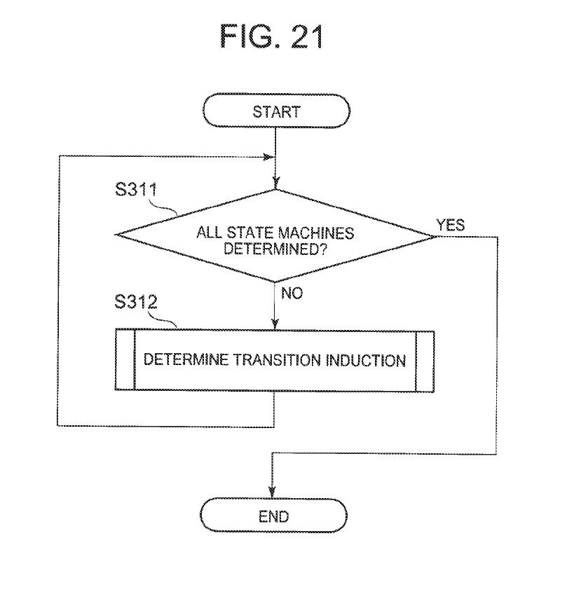

The process in step S301 is described in detail below, with reference to FIG. 21. FIG. 21 is a flowchart depicting operation of a state machine set simplifying process by the state machine simplifying unit 104.

In step S301, the state machine simplifying unit 104 sets the initial state machine set received from the state machine set conversion unit 101, as the provisional result of the simplified state machine set.

The state machine simplifying unit 104 then acquires a state machine for which whether or not a transition is induced has not been determined, from the provisional result. The state machine simplifying unit 104 determines, for the acquired state machine, the possibility that the transition included in the state machine is induced. The state machine simplifying unit 104 repeatedly performs the determination process on each undetermined state machine.

The state machine simplifying unit 104 checks whether or not all state machines in the provisional result have been determined (step S311).

In the case where all state machines have been determined (step S311: Yes), the state machine simplifying unit 104 sets the obtained provisional result as the final result, and ends the simplifying process.

In the case where all state machines have not been determined (step S311: No), the state machine simplifying unit 104 acquires one undetermined state machine. The state machine simplifying unit 104 determines the possibility that the transition included in the acquired state machine is induced (step S312).

The process of determining the possibility that the transition is induced in step S312 has a process recursive call structure of calling the process of determining the possibility that the transition included in another state machine related to the transition determined in the process is induced.

In the case where a process call loop occurs, a recursive call in the loop needs to be stopped. To determine whether or not a call loop occurs, the state machine simplifying unit 104 passes stack data including chain information of state machines being processed, upon calling the process.

In the first process in step S312, the state machine simplifying unit 104 first calls the process of determining the possibility of transition induction. In other words, the state machine simplifying unit 104 calls the process with empty stack data. After determining the possibility of transition induction, the state machine simplifying unit 104 performs the process in step S311 again.

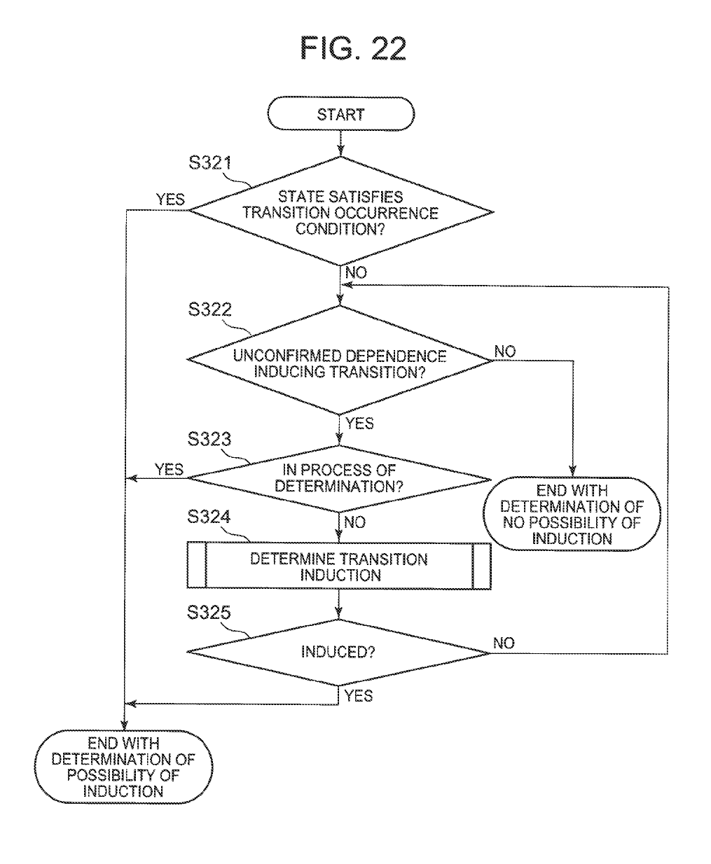

The process in step S312 is described in detail below, with reference to FIG. 22. FIG. 22 is a flowchart depicting operation of a process of determining a state machine having a possibility of transition induction by the state machine simplifying unit 104.

The state machine simplifying unit 104 determines whether or not a desired state different from the current state is included in the state machine to be determined (step S321).

In the case where a desired state different from the current state is included in the state machine (step S321: Yes), the state machine simplifying unit 104 determines that there is a possibility that the transition included in the state machine to be determined is induced, and ends the process for the state machine.

In the case where no desired state different from the current state is included in the state machine (step S321: No), the state machine simplifying unit 104 determines whether or not an unconfirmed transition condition designating a state other than the current state is present (step S322).

In the case where no unconfirmed transition condition designating a state other than the current state is present (step S322: No), the state machine simplifying unit 104 determines that there is no possibility that the transition included in the state machine is induced, and ends the process for the state machine.

In the case where an unconfirmed transition condition designating a state other than the current state is present (step S322: Yes), the state machine simplifying unit 104 acquires a state machine including a transition that complies with the unconfirmed transition condition. The state machine simplifying unit 104 determines the possibility that the transition included in the acquired state machine is induced. The state machine simplifying unit 104 repeatedly performs the determination process on each state machine including a transition that complies with the unconfirmed transition condition.

To determine the possibility that the transition included in the acquired state machine is induced, the state machine simplifying unit 104 determines whether or not the acquired state machine is included in the stack for determining a recursive call loop (step S323). In the case where the acquired state machine is included in the stack (step S323: Yes), the state machine determination process is in a loop.

In such a case, the state machine simplifying unit 104 determines that there is a possibility that the transition included in the currently determined state machine is induced, and ends the process for the state machine. In the case where the acquired state machine is included in the stack, all transitions included in the state machines in the stack are eventually determined as having a possibility of being induced.

In the case where the acquired state machine is not included in the stack (step S323: No), the state machine simplifying unit 104 adds the acquired state machine to the stack. Having added the acquired state machine, the state machine simplifying unit 104 recursively calls the process of determining the possibility that the transition in the acquired state machine is induced (step S324).

The state machine simplifying unit 104 then checks the result of the recursively called process (step S325). In the case where there is a possibility that the transition in the state machine included in the recursively called process is induced (step S325: Yes), the state machine simplifying unit 104 determines that there is a possibility that the transition in the currently determined state machine is induced, and ends the process for the state machine.

In the case where there is no possibility that the transition in the state machine included in the recursively called process is induced (step S325: No), the state machine simplifying unit 104 performs the process in step S322 again.

[Advantageous Effects]

The change planning system in this exemplary embodiment can generate an operation procedure more efficiently, from definition information about components, dependence, and operations represented by a plurality of state machines and transition conditions between state machines.

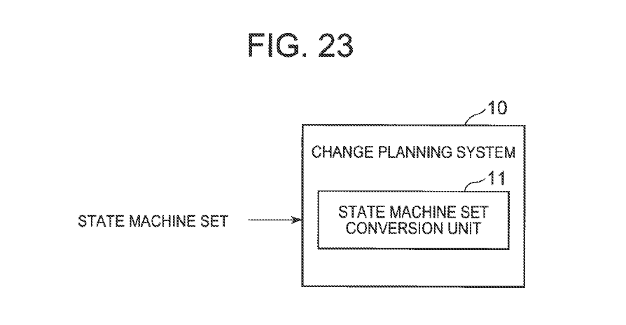

The following describes the overview of the present invention. FIG. 23 is a block diagram schematically depicting a change planning system according to the present invention. A change planning system 10 according to the present invention includes a state machine set conversion unit 11 (e.g. the state machine set conversion unit 101) which converts a state machine set made up of one or more state machines, into a single state machine including one or more states, wherein a state in a state machine included in the state machine set transitions to another state according to a transition condition designating a state in a state machine included in the state machine set other than the state machine, wherein a state in the single state machine corresponds to a state of all state machines in the state machine set, and wherein, while the transition condition according to which the state in the state machine makes a predetermined transition is satisfied, the state in the single state machine transitions to another state corresponding to another state of all state machines that results from the predetermined transition.

With such a structure, the change planning system can generate a change plan from a state machine set including a transition condition, using an efficient computation algorithm.

Moreover, in the change planning system 10, the state in the state machine may transition according to the transition condition which is a combination of a plurality of conditions.

With such a structure, the change planning system can generate a change plan from a state machine set including a complex transition condition.

Moreover, the state machine set conversion unit 11 may set, in the states in the single state machine, a current state and a desired state of each state machine included in the state machine set.

With such a structure, the change planning system can generate a change plan in which the states in state machines included in a state machine set are reflected.

Moreover, the change planning system 10 may include a path search unit (e.g. the path search unit 102) which generates transition order made up of one or more predetermined transitions, the transition order being a basis of order used when the state in the single state machine transitions.

With such a structure, the change planning system can generate a change plan from a state machine set in which a plurality of transitions relate to each other.

Moreover, the change planning system 10 may include a transition order conversion unit (e.g. the transition order conversion unit 103) which converts transition order as a totally ordered set into transition order as a partially ordered set, by providing ordering only between transitions of states in a plurality of state machines associated by a transition condition.

With such a structure, the change planning system can generate a change plan having a shorter total execution time.

Moreover, the change planning system 10 may include a state machine simplifying unit (e.g. the state machine simplifying unit 104) which specifies a state machine having no possibility that a transition of a state in the state machine is induced, and removes the state machine and a transition condition relating to the state machine from the state machine set.

With such a structure, the change planning system can reduce computational effort in system change plan generation.

Moreover, the state machine simplifying unit may remove, from among the states in the single state machine, a state to which a current state is unable to transition.

With such a structure, the change planning system can reduce computational effort in system change plan generation.

The computation algorithm of the technique described in NPL 5 has problems in that the computation procedure for finding an optimal solution is inefficient and that a solution, even though exists, might not be obtained.

The computation algorithm described in NPL 5 is based on trial and error computation of randomly trying transitions satisfying transition conditions and, in the case of a failure, retrying. The computation procedure is inefficient because unnecessary search is repeated.

The reason why a solution which exists might not be obtained is that the computation algorithm omits a search case for a solution estimated to be not optimal on the basis of predetermined criteria, to enhance computation efficiency.

According to the present invention, a change plan can be generated from a state machine set including a transition condition, using an efficient computation algorithm.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A change planning system comprising
a state machine set conversion unit which converts a state machine set made up of one or more state machines, into a single state machine including one or more states,
wherein a state in a state machine included in the state machine set transitions to another state according to a transition condition designating a state in a state machine included in the state machine set other than the state machine,
wherein a state in the single state machine corresponds to a state of all state machines in the state machine set, and
wherein, while the transition condition according to which the state in the state machine makes a predetermined transition is satisfied, the state in the single state machine transitions to another state corresponding to another state of all state machines that results from the predetermined transition.

2. The change planning system according to claim 1, wherein the state in the state machine transitions according to the transition condition which is a combination of a plurality of conditions.

3. The change planning system according to claim 1, wherein the state machine set conversion unit sets, in the states in the single state machine, a current state and a desired state of each state machine included in the state machine set.

4. The change planning system according to claim 1, comprising
a path search unit which generates transition order made up of one or more predetermined transitions, the transition order being a basis of order used when the state in the single state machine transitions.

5. The change planning system according to claim 4, comprising
a transition order conversion unit which converts transition order as a totally ordered set into transition order as a partially ordered set, by providing ordering only between transitions of states in a plurality of state machines associated by a transition condition.

6. The change planning system according to claim 1, comprising
a state machine simplifying unit which specifies a state machine having no possibility that a transition of a state in the state machine is induced, and removes the state machine and a transition condition relating to the state machine from the state machine set.

7. The change planning system according to claim 6, wherein the state machine simplifying unit removes, from among the states in the single state machine, a state to which a current state is unable to transition.

8. A change planning method executed in a change planning system for converting a state machine set made up of one or more state machines into a single state machine including one or more states,
wherein a state in a state machine included in the state machine set transitions to another state according to a transition condition designating a state in a state machine included in the state machine set other than the state machine,
wherein a state in the single state machine corresponds to a state of all state machines in the state machine set, and
wherein, while the transition condition according to which the state in the state machine makes a predetermined transition is satisfied, the state in the single state machine transitions to another state corresponding to another state of all state machines that results from the predetermined transition.

9. A non-transitory computer-readable recording medium having recorded therein a change planning program that, when executed by a computer,
converts a state machine set made up of one or more state machines, into a single state machine including one or more states,
wherein a state in a state machine included in the state machine set transitions to another state according to a transition condition designating a state in a state machine included in the state machine set other than the state machine,
wherein a state in the single state machine corresponds to a state of all state machines in the state machine set, and
wherein, while the transition condition according to which the state in the state machine makes a predetermined transition is satisfied, the state in the single state machine transitions to another state corresponding to another state of all state machines that results from the predetermined transition.
